(19) United States
(12) Patent Application Publication
(10) Pub. No.: US 2016/0217880 A1
(43) Pub. Date: Jul. 28, 2016

(54) ULTRAVIOLET LIGHT SOURCE AND METHODS

(71) Applicant: RayVio Corporation, Hayward, CA (US)

(72) Inventors: Yitao LIAO, Redwood City, CA (US); Douglas A. COLLINS, Hayward, CA (US)

(21) Appl. No.: 14/604,536

(22) Filed: Jan. 23, 2015

(51) Int. Cl. G21K 5/02

(52) U.S. Cl. CPC G21K 5/02

(57) ABSTRACT

A UV light emitting apparatus for illuminating a subject matter includes a first UV-LED and second UV-LED configured to output different frequencies of light within in a frequency band from about 210 nm to about 365 nm, a memory for storing configuration data, a processing unit for determining power control signals in response to the configuration data, and a power supply for providing power to the first and the second UV-LEDs in response to the power control signals, wherein the first and the second UV-LEDs provide UV light at frequencies directed to one or more UV light sensitivity peaks of the subject matter.

### BACKGROUND OF THE INVENTION

The present invention relates to UV lighting. More specifically, the present invention relates to a light source with configurable UV light band output.

Several commercially available sources exist for output of UV light. One source involves a medium-pressure mercury lamp source. The output of such a lamp source typically spans a wide range of UV frequencies, e.g. from 200 nm to 400 nm. Another source is a low-pressure mercury lamp that has a narrow peak within the UV range of about 254 nm. Drawbacks for using such gas-discharge lamps include that such sources are very fragile because the gasses are encapsulated in glass. The fragile nature of the glass disqualifies such lamp sources for use in many industrial applications where there are physical shocks, temperature shocks, electrical surges, and the like. Still further, in many jurisdictions, mercury lamp sources are outlawed or will be outlawed due to the mercury content. Accordingly, mercury lamp sources do not provide a practical source of configurable UV light for commercial or industrial applications in the future.

Another commercially-available UV source involves the use of light emitting diodes (LEDs). More specifically, these LEDs are based upon InGaN material. Drawbacks with commercially-available InGaN LEDs include that they cannot supply UV light lower at frequencies lower than 365 nm. Accordingly, InGaN LEDs cannot be used for many biological applications, many print/ink applications, or the like.

From the above, it is desired to have an ultraviolet light source without the drawbacks described above.

### BRIEF SUMMARY OF THE INVENTION

The present invention relates to UV lighting. More specifically, the present invention relates to a light source with configurable UV light band output. Additionally, the present invention relates to an ultraviolet light LED source with configurable emission that emits UV light in the wavelength range below 365 nm.

Embodiments of the present invention include a plurality of UV-LEDs, wherein different UV-LEDs of the plurality of UV-LEDs output UV light at different UV wavelengths. In various embodiments, the UV wavelengths include at least wavelengths lower than 365 nm bands. Additionally, in other embodiments, the UV wavelengths also include wavelengths above 365 nm. In various embodiments, the UV-LEDs may be arranged in a row, an array, or other desired pattern.

Another embodiment of the present invention includes using a plurality of UV-LEDs to reproduce the essential emission components of a mercury lamp, without drawbacks, described above. For example, a UV-LED with peak emission wavelength at 254 nm can be used to reproduce the emission from a low pressure mercury lamp. Yet another embodiment of the present invention includes using a plurality of UV-LEDs to reproduce the essential emission peaks of a medium pressure mercury lamp, including, but not limited to peak emissions at wavelengths of: 256 nm, 303 nm, 313 nm and 356 nm. In still other embodiments, a combination of UV-LEDs can be used to reproduce the essential emission peaks of other gas-discharge lamps, including high pressure mercury lamps, metal halide lamps, xenon lamps, or the like. In such embodiments, unwanted UV wavelengths generated by such mercury lamps are minimally reproduced, if at all, by the combination of UV-LEDs. For example, in addition to the above-described peak emissions, medium pressure mercury lamps typically generate a significant amount of UV light at 240 nm. This frequency of UV light produces ozone. In current applications of medium pressure mercury lamps such as the print industry, so much ozone is produced that workers are required to use respirator devices. In contrast, in current embodiments, no significant amounts of UV light at 240 nm is output.

Yet another embodiment of the present invention includes using a plurality of UV-LEDs to produce emission in the UV wavelength range, where the emission characteristics include two or more individual, single-peaked UV emission with its full width half maximum (FWHM) in the range between 5 nm and 30 nm. In some embodiments, the emission includes one or more individual, single-peaked UV emission in a UV frequency range lower than 365 nm. In some embodiments, the peak positions of the emission from the plurality of UV-LEDs substantially overlap with and are centered with respect to two or more most intense peaks within +/−5 nm range of an arc lamp type UV emitter (such as, a medium pressure mercury lamp, or a Xenon lamp).

Another embodiment of the present invention includes using a plurality of UV-LEDs to produce emission spectrum that substantially matches the spectral characteristics of a pre-defined sensitivity, response, or efficacy spectrum of a subject matter. For example, a plurality of UV-LEDs can be selected that have an emission peak of that matches a UV sensitivity frequency of DNA (e.g. about 265 nm to about 275 nm), RNA (e.g. 230 nm, 260 nm, 280 nm), virus (e.g. about 228 nm to about 298 nm), germs (e.g. about 207 nm), pathogens, or the like. In some embodiments, a plurality of UV-LEDs can be selected to match the UV absorption peaks of certain ink mixtures or photo-initiator systems. As an example, a certain ink or ink mixture may include photo-initiators that are sensitive to UV light at the frequencies of 210 nm, 260 nm, 310 nm and 380 nm. Accordingly, one embodiment of the present invention may activate a first set of UV-LEDs that have an emission peak of about 210 nm, activate a second set of UV-LEDs that have an emission peak of about 260 nm, activate a third set of UV-LEDs that have an emission peak of about 310 nm, and activate a fourth set of UV-LEDs that have an emission peak of about 380 nm. The power output of the different sets of UV-LEDs may be the same or different, depending upon the sensitivity of the ink or ink mixture. In additional applications, ink or print curing initiators may also include activation of sets of UV-LEDs that have emission peaks within the range from 365 nm to 400 nm. Based upon the inventors' study, print or ink curing initiators have a majority of their absorbance within UV wavelengths within the range of 210 nm to 220 nm, 260 nm to 280 nm, 300 nm to 320 nm, or the like. These wavelength ranges have not been addressed by existing UV-LEDs. Embodiments of the present invention are now capable of outputting UV light at these wavelengths.

Yet another embodiment of the present invention includes using a plurality of UV-LEDs to produce emission in the UV wavelength range lower than 365 nm. In some embodiments, the emission comprises two or more individual, single-peaked UV emission with its full width half maximum (FWHM) in the range between 5 nm and 30 nm; the emission comprises one or more individual, single-peaked UV emission in the range lower than 365 nm; the peak positions of the emission from the plurality of UV-LEDs substantially overlap with and are centered with respect to two or more most intense peaks within +/−5 nm range of a pre-defined sensitivity, response, or efficacy spectrum of a subject matter, such as, but not limited to, UV absorbance of DNA, UV absorbance spectrum of certain ink or photo-initiator systems, UV wavelengths of optical communications systems (e.g. lasers).

Another technology involves the use of light emitting diodes (LEDs). UV-LEDs based on the nitride materials (InGaN, GaN, AlN and AlGaN) can cover the entire UV emission wavelength range from 400 nm to 210 nm.

Embodiments also include a processing unit and configuration memory, and a power supply. In some embodiments, the configuration memory stores one or more sets of configuration data. The configuration data typically specifies data associated with a desired UV light output profile (including, but not limited to, emission spectrum and optical power) desired for the light source. For example, one configuration may specify UV light output at 100% at 260 nm and UV light output at 50% at 320 nm; another configuration may specify UV light output at 75% at 265 nm, UV light output at 50% at 275 nm, and UV light output at 50% at 311 nm; and the like.

In response to a set of configuration data from the configuration memory, the processing unit selectively supplies power from power supply to the UV-LEDs. In various embodiments, the processing unit may vary various parameters of the power to control the UV output. For example, in some embodiments, the processing unit may vary an output voltage, a duty cycle, a current, or the like to vary the power output to the various UV-LEDs.

According to one aspect of the invention, a UV light emitting apparatus is disclosed. One device may include a first plurality of UV-LEDs, wherein the first plurality of UV-LEDs are configured to output light primarily in a first frequency band being from 210 nm to 365 nm, and a second plurality of UV-LEDs, wherein the second plurality of UV-LEDs are configured to output light primarily in a second UV frequency band, wherein the second UV frequency band is not identical to the first frequency band. An apparatus may include a memory configured to store at least one UV light output configuration data, and a processing unit coupled the memory, wherein the processing unit is configured to provide a plurality of UV LED power control signals in response to the UV light output configuration data. A system may include a power supply portion coupled to the first plurality of UV-LEDs, to the second plurality of UV-LEDs, and to the processing unit, wherein the power supply portion is configured to provide a plurality of power outputs, wherein the power supply portion is configured to provide a first power output from the plurality of power outputs to each of the first plurality of UV-LEDs and to provide a second power output from the plurality of power outputs to each of the second plurality of UV-LEDs, in response to the plurality of UV LED power control signals from the processing unit.

Various additional objects, features and advantages of the present invention can be more fully appreciated with reference to the detailed description and accompanying drawings that follow

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 illustrates a functional block diagram of various embodiments of the present invention;

FIG. 2 illustrates an example of various embodiments of the present invention; and

FIGS. 3A-B illustrate block diagrams of flow processes according to various embodiments of the present invention.

### DETAILED DESCRIPTION OF THE INVENTION

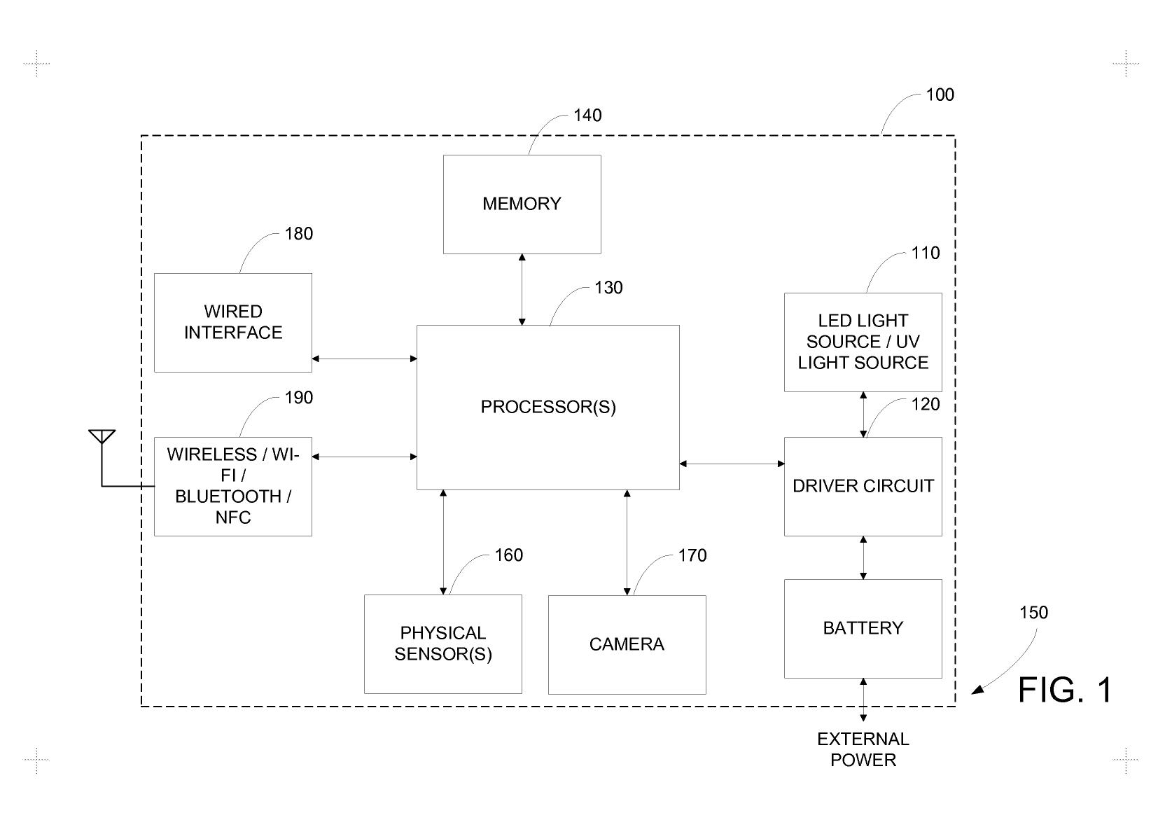

FIG. 1 illustrates a block diagram of an embodiment of the present invention. More specifically, FIG. 1 illustrates a UV light source 100 having a plurality of UV-LEDs 110. UV-LEDs 110 are coupled to a driver circuit 120 controlled by a processing unit 130. In various embodiments, processing unit 130 controls power provided by drive circuit 120 to UV-LEDs 110 referring to configuration data stored in a memory store 140. In some embodiments, UV light source 100 may be powered from an internal power supply or an external supply 150. In the embodiment illustrated in FIG. 1, UV light source may also include one or more physical sensors 160, a camera 170, and a wired 180 or wireless interface 190.

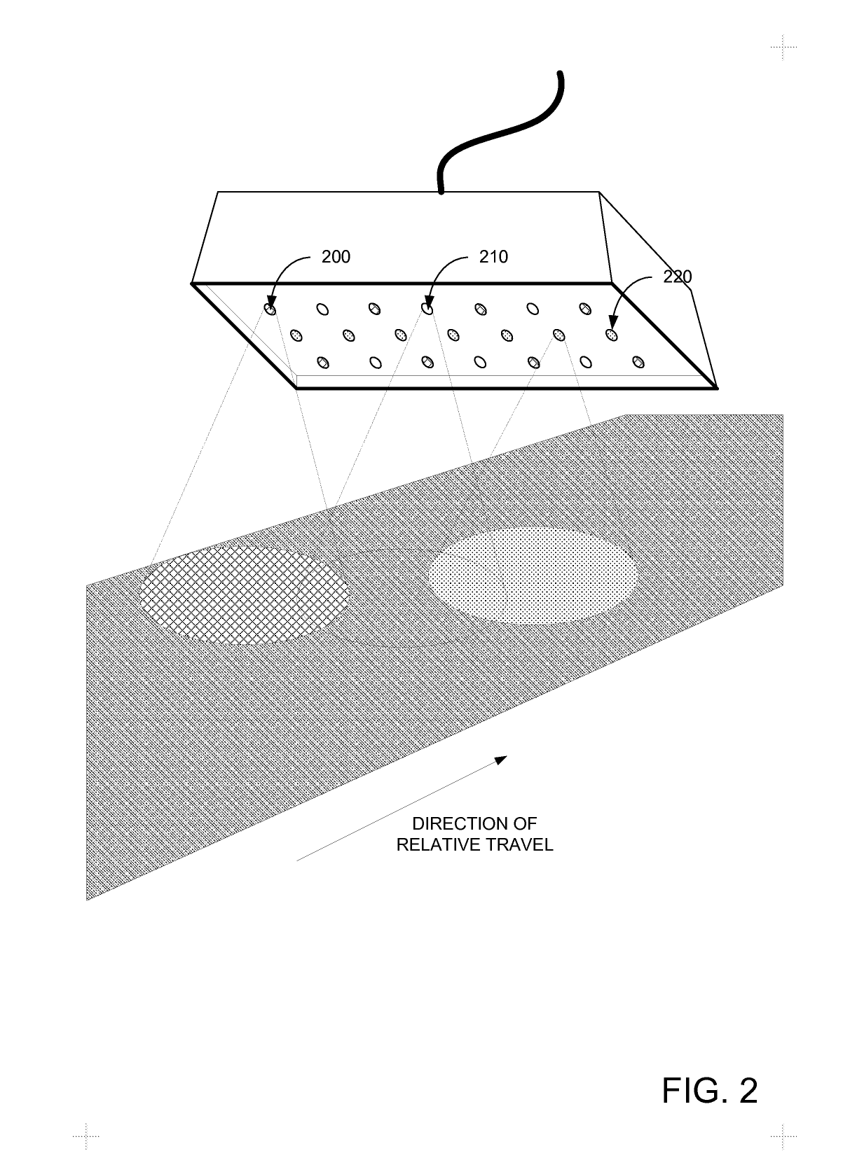

In various embodiments, UV-LEDs 110 may include any number of UV-LEDs, where each UV LED may have a unique UV light output peak. As an example configuration, as illustrated in FIG. 2, UV-LEDs 110 may be divided into three groups of UV-LEDs (200, 210 and 220). In various embodiments, group 200 may be configured to provide UV light in the range of about 260 nm, group 210 may be configured to provide UV light in the range of about 320 nm, and group 220 may be configured to provide UV light in the range of about 380 nm. In other embodiments, the number of groups may be increased, for example five groups, six groups, etc., and each group may be configured to provide UV light output at frequencies close to each other, for example, UV light output at 260 nm, 280 nm, 300 nm, 320 nm, and the like. In various embodiments, selection of UV light output may be dependent upon the desired application for UV light source 100, as described herein.

In some embodiments, UV-LEDs (e.g. 200, 210 and 220) may each have integrated lenses that disburse the produced UV light, as shown in FIG. 2. In other embodiments, wafer material including UV-LEDs (e.g. 220) are placed upon a circuit board, e.g. 230, and a single linear barrel-type or rib-like lens may be disposed above each of the UV-LEDs 220, for example. In general, two or more UV-LEDs may share a lens or reflector in various embodiments.

In some embodiments, the UV light output requirements of UV light source 100 is known ahead of time, and the peak output frequencies for UV-LEDs 110 are tailored to the output requirements. In other embodiments, a UV light source 100 may have UV-LEDs having output frequencies spaced apart every 20 nm from 180 nm to 400 nm. In various embodiments, this capability is enabled by UV-LEDs under development by Rayvio that have a bandwidth of approximately 15 nm to 20 nm+/−5 nm. In contrast, other conventional UV-LEDs have a relatively narrow bandwidth of less than 12 nm.

In various embodiments, UV-LEDs 110 are based upon UV-LEDs currently under development by the assignee of the present invention, Rayvio, Inc. In various embodiments, the UV-LEDs are based upon Aluminum Gallium Nitride (AlGaN). The inventors of the present invention have discovered that by modifying the amount of aluminum (e.g., from 0 to 100%), in the AlGaN material, the wavelength of UV light can be fine-tuned. For example, when the percentage of aluminum is approximately 40%, the primary output wavelength is about 290 nm; when the percentage of aluminum is approximately 60%, the primary output wavelength is about 260 nm; and the like. In other embodiments, it is contemplated that when other vendors achieve similar capability, UV LED light sources from other vendors can be used.

As illustrated in FIG. 1, UV-LEDs 110 are coupled to driver circuit 120. In various embodiments, driver circuit 120 provides power to UV-LEDs 110, under the control of processing unit 130. The power provided may have a number of power parameters that can be controlled. For example, in some embodiments, the power parameters may include drive voltage or magnitude, maximum current, duty cycle, or the like. By varying the power parameters, the output of UV-LEDs 110 may be controlled, for example, from zero output to 100% output.

In various embodiments, the power parameters may be static or time varying, depending upon specific application. For example, in an ink curing application, during a first period of time more power (e.g. higher voltage, higher duty cycle, etc.,) may be directed to a set of UV-LEDs having a peak at 260 nm, and during a second period of time the power may be reduced (e.g. lower voltage, lower duty cycle, etc.) to these set of UV-LEDs. The adjustments may be made responsive to the type of ink, or the like the UV light source 100 is illuminating.

In various embodiments, driver circuit 120 is controlled by processing unit 130. Processing unit 130 may be a microprocessor, a microcontroller, static a state machine, or the like. In various embodiments, processing unit 130 controls driver circuit 120 based upon configuration data. The configuration data may be specified by a user or may be determined by processing unit 130, based upon input of the type of material UV light source 100 will illuminate. For example, in some embodiments, a user may specify output of UV light at 100% at 250 nm, UV light at 50% at 275 nm, UV light at 75% at 300 nm, and the like to target specific pathogens or the like. In other embodiments, the composition of ink to dry, for example, is provided to processing unit 130, and in response, processing unit 130 determines the specific power outputs for the provided UV-LEDs 110.

Illustrated in FIG. 1 is a memory store 140 for storing one or more sets of configuration data as discussed above. Additionally, in some embodiments, memory store 140 may store an association table, or the like between a composition of ink to dry, for example, and the required UV light output. In various embodiments, configuration data or other data stored in memory 140 may be received from a wired interface 180 or a wireless interface 190. In some examples, a wired interface 180 may include a USB type interface, or other conventional or proprietary interface. Additionally, in some examples, a wireless interface 190 may include a Wi-Fi interface, a short range radio interface (e.g. Bluetooth, ZigBee), NFC interfaces, or the like.

In some embodiments, memory store 140 may also include one or more programs can be executed on processing unit 130. In one example, one or more sensors, discussed in detail, below, may monitor a surface to be illuminated, and in response, processing unit 130 may illuminate the surface with the appropriate UV light frequencies, and with the appropriate intensities. In another example, processing unit 130 may receive a formulation of ink, for example, and processing unit 130 may again determine the appropriate UV-LEDs to illuminate at appropriate intensities. In various embodiments, the power settings for the UV-LEDs may be specified by the configuration data and/or determined dynamically by processing unit 130.

In some embodiments of the present invention, physical sensors 160 as well as a camera 170 may also be integrated into UV light source 100. Physical sensors 160 may include accelerometers, gyroscopes, pressure sensors, temperature sensors, flow rate monitors, and the like. It is contemplated that physical sensors 160 may monitor the configuration of UV light source 100 within an industrial environment. In some cases, if UV light source 100 is subjected to too high temperatures or pressures, under the direction of processing unit 130, UV light source 100 may be switched off, switched into a lower power mode or the like. In some embodiments, camera 170 may be used to monitor a surface where UV light source 100 will illuminate. Images acquired by camera 170 may be used by processing unit 130 to determine which UV-LEDs to power-on, which to power-off, or the like. For example, when camera 170 “sees” a surface with a yellow ink coloring, processing unit 130 powers-on specific UV-LEDs to cure the yellow ink or ink mixture. In some embodiments, the images acquired by camera 170 may be used for safety purposes. For example, if camera 170 does not detect the surface to illuminate, the UV-LEDs 110 may be powered off, so a human is not inadvertently exposed to the UV light.

In other embodiments, physical sensors 160 may provide feedback for UV light source 100 to adjust its operating parameters. For example, a temperature sensor may monitor the temperature of the subject matter that is exposed to UV light. If the temperature is lower than a target temperature, the amount of UV light may be increased (e.g. the power is increased), if the temperature is higher than a target temperature, the amount of UV light may be decreased, or the like. In another example, the opacity of a fluid (e.g. water) to treat is monitored. In such a case, if the opacity of the fluid increases, the power of the UV light output is increased dynamically, if the opacity of the fluid decreases, the power of the UV-LEDs is decreased, or the like. In another example, the flow rate of a gas to treat is monitored. In such a situation, if the flow rate increases, the amount of UV light output by particular UV-LEDs may also increase. Further, in another example, if the relative movement rate of the subject matter to expose relative to the UV-LEDs increases, the power of the UV-LEDs may also be increased, decreased, or the like. Other physical parameters may also be monitored and used to control the output power of the UV-LEDs, such as vibration or shaking of a surface, change in color or appearance (e.g. texture, roughness, shine) of the subject matter, amount of pressure or vacuum applied to the subject matter, and the like. In addition, the output parameters of UV light source may also be changed such as the output power (e.g. current, voltage, duty cycle, waveform); the frequencies of UV output (e.g. activate a first set of UV-LEDs (e.g. 260 nm peak) until a physical event occurs, then activate a second set of UV-LEDs (e.g. 280 nm peak); or the like. In light of the present patent disclosure, one of ordinary skill in the art will recognize other types of physical parameters of a subject matter may be monitored and used to adjust not only the power output of UV-LEDs, but also which frequencies of UV-LEDs to activate.

In still other embodiments, one or more visible light indicators may be provided to indicate operation of one or more UV-LEDs and the generation of UV light.

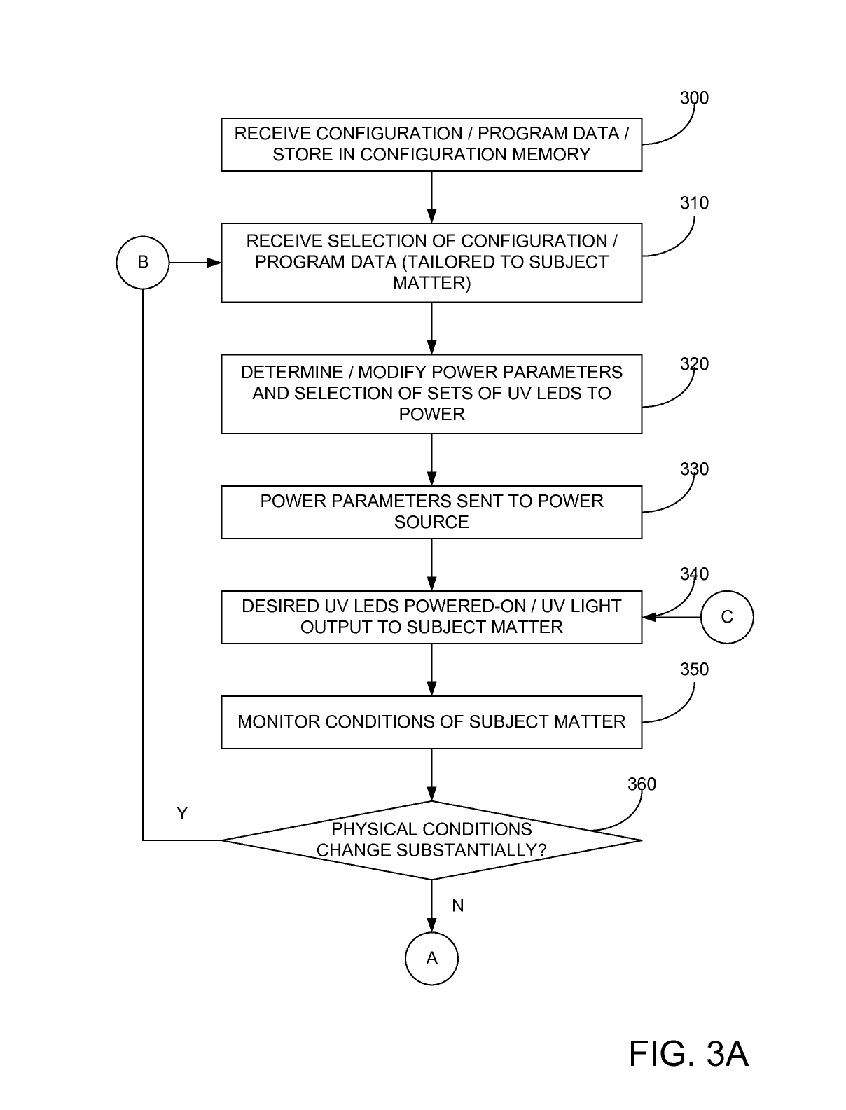

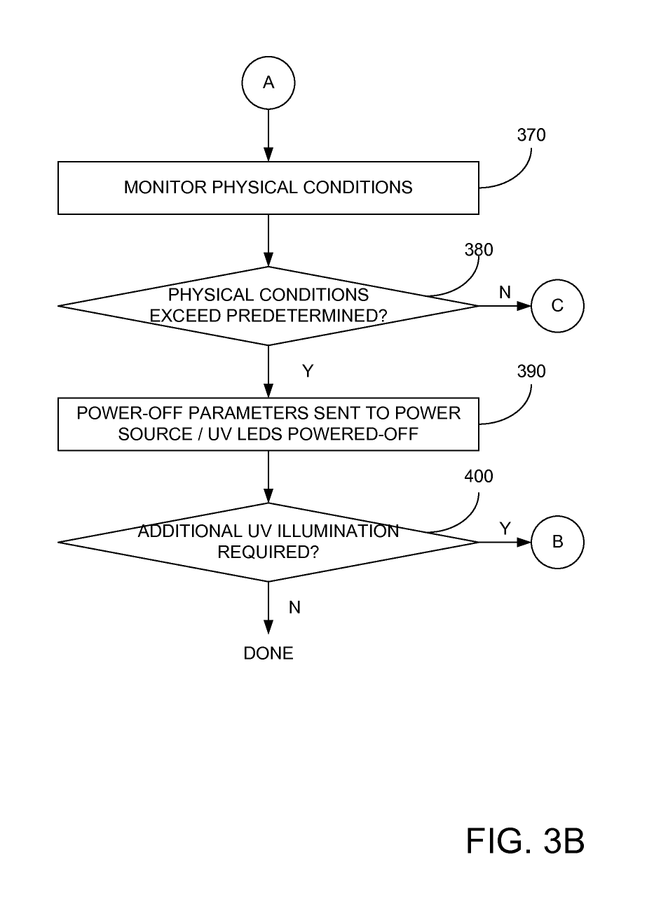

FIGS. 3A-B illustrate a block diagram of a process according to various embodiments of the present invention. Initially, one or more sets of configuration data and/or program data are stored in the memory of the UV light source, step 300. The stored data may be uploaded to the UV light source during production of the UV light source, or after delivery to a customer. Various mechanisms may be used, such as a wired connection or wireless connection.

Next, when the UV light source is to be used, a processor may receive a selection of configuration data and/or program data to use from the memory, step 310. In some embodiments, steps 300 and 310 may be combined into one step, in cases where only a single set of configuration data or a single program is used.

Based upon this data, the processing unit determines which UV-LEDs to power, and the appropriate power parameters, step 320. In some embodiments, the configuration data may directly specify which UV-LEDs to power and the intensities (power parameters). In other embodiments, the processing unit may determine the power parameters based upon the program or the configuration data.

Subsequently, the power parameters are provided to the UV LED drivers, step 330. In some embodiments, the power parameters may specify which UV-LEDs to power, as well as the specific intensity. In response to the power parameters, the UV LED drivers may determine a driving voltage, a duty cycle, a maximum current, or the like. In some embodiments, the UV LED drivers may simply use the power parameters provided by the processing unit to drive the UV-LEDs, e.g. the processing unit may specify a 50% duty cycle, or the like. In various embodiments, the UV-LEDs illuminate the desired surface, step 340.

In various embodiments of the present invention, any number of parameters associated with the subject matter may be monitored, step 350. For example, the temperature, appearance, flow rate, color, atmospheric pressure, speed of relative movement, or the like, may be monitored. If these changes in parameters exceed a predetermined threshold, step 360, the process may return to steps 310 or 320 for recomputation of the power parameters. In some cases, a power output of a UV-LED may be increased; different frequencies of UV-LEDs may be activated/deactivated; or the like. In some cases, the configuration data may change based upon changing physical parameters, and in other cases, the configuration data stays the same, but the power parameters are changed.

In FIGS. 3A-B, any number of physical conditions of the UV light source itself may be monitored, step 370. For example, some parameters may include: the temperature of the UV LED source, the illumination time, the forces experienced by the UV LED source, and the like. In various embodiments if the physical conditions are exceeded, step 380, the UV illumination is terminated, step 390. Some examples of physical conditions include monitoring overheating of the UV-LEDs, monitoring UV exposure time of a surface or article, monitoring vibrations of UV LED source, and the like.

In various embodiments, if desired, step 400, the UV exposure process may be repeated with different sets of UV LED power parameters, step 310. As an example, exposure of a surface may require a several UV illumination step process, with specific time intervals between exposures. Other algorithms and configurations for UV light illumination are also envisioned.

Representative claims include: A UV light emitting apparatus comprising: a first plurality of UV-LEDs, wherein the first plurality of UV-LEDs are configured to output light primarily in a spectrum frequency band from 210 nm to 365 nm; a second plurality of UV-LEDs, wherein the second plurality of UV-LEDs are configured to output light primarily in a second UV frequency band, wherein the second UV frequency band is not identical to the first frequency band; a memory configured to store at least one UV light output configuration data; a processing unit coupled the memory, wherein the processing unit is configured to provide a plurality of UV LED power control signals in response to the UV light output configuration data; and a power supply portion coupled to the first plurality of UV-LEDs, to the second plurality of UV-LEDs, and to the processing unit, wherein the power supply portion is configured to provide a plurality of power outputs, wherein the power supply portion is configured to provide a first power output from the plurality of power outputs to each of the first plurality of UV-LEDs in response to the plurality of UV LED power control signals from the processing unit.

In some embodiments, the spectrum of the UV lighting apparatus overlaps substantially to two or more peaks of a pre-defined sensitivity, response, or efficacy spectrum of a subject matter. In some embodiments, different UV-LEDs belonging to the first plurality of UV-LEDs have different emission peak wavelengths. For example, two UV-LEDs output UV light peaking at about 260 nm, two UV-LEDs output UV light peaking at 270 nm, two UV-LEDs output light peaking at 290 nm, or the like. In some embodiments, all UV-LEDs belonging to the first plurality of UV-LEDs has substantially a similar emission peak wavelength (e.g. peaking at 265 nm) light.

In some embodiments, the spectrum includes UV frequency peaks directed to UV absorbance of DNA. In some embodiments, the spectrum includes UV absorbance peaks directed to UV absorbance of RNA. In some embodiments, the spectrum includes UV absorbance peaks directed to UV absorbance of a bacteria or a virus, or a pathogen, or group of bacteria, or a group of virus, or a group of pathogen. In some embodiments, the spectrum includes a UV absorbance peaks directed to UV absorbance of a type of ink or ink mixture. In some embodiments, the spectrum includes a UV absorbance peaks directed to UV absorbance a type of photo-initiator. In some embodiments, the spectrum includes a UV absorbance peaks directed to UV absorbance of organic matter. Based upon the known UV sensitivity of the subject matter, the UV lighting apparatus can activate specific UV-LEDs in an array that provide the desired frequency of UV light. In still other embodiments, a subject matter to be exposed may require that a first particular range of UV light is to be avoided, but a second particular range of UV light is to be used. In such cases, UV-LEDs would be activated directed towards the second particular range of UV light (e.g. 275 nm), but UV-LEDs would not be activated directed towards the first particular range of UV light (e.g. 300 nm). In still other embodiments, the spectrum includes UV frequency peaks used in UV communications systems (e.g. lasers from 200 nm to about 280 nm), and different sets of UV-LEDs in the unit may send and receive communications at different frequencies (e.g. 260 nm, 280 nm, etc.).

In some embodiments, specific UV-LEDs in an array of UV-LEDs will have peak frequencies separated by about 20 nm, e.g. first set 210 nm, second set 30, or the like. In other embodiments, the peaks may be spaced further apart or may be closer together, depending upon specific requirements.

In some embodiments, the UV light source may be modular in nature, such that additional UV light output modules may be easily attached/detached from a central control unit. In various embodiments, the central control unit (including a memory, processor), may provide the electronic power for the additional UV light output modules via a power unit in the central control unit. In other embodiments, UV light output modules have their own power supply, but may be under the control of the central control unit. Based upon the detected configuration of modules, the central control unit may adjust the intensity and/or wavelengths of the UV light output. As an example, by doubling the number of UV-LEDs of a particular frequency (by adding an additional module), the driving power for each UV-LED of the particular frequency may be increased, decreases, or be held constant, or the like.

Further embodiments can be envisioned to one of ordinary skill in the art after reading this disclosure. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in additional embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

We claim:

1. A UV light emitting apparatus for illuminating a subject matter comprising:
a first plurality of UV-LEDs, wherein the first plurality of UV-LEDs are configured to output light primarily in a frequency band from 210 nm to 365 nm;
a second plurality of UV-LEDs, wherein the second plurality of UV-LEDs are configured to output light primarily in a second UV frequency band, wherein the second UV frequency band is not identical to the first frequency band;
a memory configured to store at least one UV light output configuration data;
a processing unit coupled the memory, wherein the processing unit is configured to provide a plurality of UV LED power control signals in response to the UV light output configuration data; and
a power supply portion coupled to the first plurality of UV-LEDs, to the second plurality of UV-LEDs, and to the processing unit, wherein the power supply portion is configured to provide a plurality of power outputs, wherein the power supply portion is configured to provide a first power output from the plurality of power outputs to each of the first plurality of UV-LEDs in response to the plurality of UV LED power control signals from the processing unit;
wherein the first plurality of UV-LEDs provides UV light directed to one or more UV sensitivity peaks of the subject matter.

2. The apparatus of claim 1 wherein the subject matter is selected from a group consisting of: DNA, RNA, a bacteria, a virus, a pathogen, and organic matter.

3. The apparatus of claim 1 wherein the subject matter is selected from a group consisting of: a photo-sensitive compound, photo-sensitive material and a photo-initiator.

4. The apparatus of claim 1
wherein the power supply portion is configured to provide a second power output from the plurality of power outputs to each of the second plurality of UV-LEDs in response to the plurality of UV LED power control signals from the processing unit; and
wherein a power parameter for the first power output is different from a power parameter for the second power output.

5. The apparatus of claim 1 wherein the power parameter is selected from a group consisting of: voltage, current, duty cycle, wave pattern.

6. The apparatus of claim 1 wherein the first plurality of UV-LEDs is characterized by a total UV light output power within the wavelength range between 210 nm and 365 nm and within a range of about 1 milliwatt to 100 watts

7. The apparatus of claim 1 wherein the first plurality of UV-LEDs has individual power output characterized by a 1 micro Watts to about 3 Watts.

8. The apparatus of claim 1 wherein the first plurality of UV-LEDs is characterized by an external quantum efficiency within a range of about 0.1% to about 70%

9. The apparatus of claim 1
wherein the first plurality of UV-LEDs comprises AlGaN material having a first percentage of aluminum; and
wherein the second plurality of UV-LEDs comprises InGaN material having a second percentage of Indium.

10. The apparatus of claim 1
wherein the first plurality of UV-LEDs and the second plurality of UV-LEDs are approximately aligned in a first direction; and
wherein the apparatus further comprises a lens optically coupled to the first plurality of UV-LEDs and to the second plurality of UV-LEDs, wherein the lens is configured to receive the output light primarily in a first UV frequency band between 210 nm and 365 nm, and the output light primarily in a second UV frequency band between 365 nm and 420 nm, and wherein the lens is configured to output diffused output light in the first UV frequency band and in the second UV frequency band.

11. A method for a UV light emitting device comprising:
storing in a memory of the device UV light output configuration data;
determining in a processing unit, a plurality of UV LED power control signals in response to the UV light output configuration data from the memory;
supplying from a power supply portion a first power output to a first plurality of UV-LEDs and a second power output to a second plurality of UV-LEDs, in response to the plurality of UV LED power control signals from the processing unit; and
outputting from the first plurality of UV-LEDs light primarily in a frequency band between 210 nm and 365 nm to at least a first portion of a subject, in response to the first power output;
outputting from the second plurality of UV-LEDs light primarily in a second UV frequency band to at least a second portion of the subject, in response to the second power output, wherein the second UV frequency band is not identical to the first UV frequency band between 210 nm and 365 nm.

12. The method of claim 11 further comprising receiving in the device, the UV light output configuration data from an external source.

13. The method of claim 11 wherein a power parameter for the first power output is different from a power parameter for the second power output.

14. The method of claim 13 wherein the power parameter is selected from a group consisting of: voltage, current, duty cycle, wave pattern.

15. The method of claim 11 wherein the second UV frequency is selected from a range from about 365 nm to about 420 nm.

16. The method of claim 11 wherein outputting from the first plurality of UV-LEDs light primarily in a UV frequency band between 210 nm and 365 nm comprises converting the first power output into the light primarily in the first frequency band with an efficiency within a range of about 1 micro Watts to about 3 Watts.

17. The method of claim 11 wherein outputting from the first plurality of UV-LEDs light primarily in a UV frequency band between 210 nm and 365 nm comprises converting the first power output into the light primarily in the first frequency band with an external quantum efficiency within a range of about 0.1% to about 70.

18. The method of claim 11 further comprising:
directing the light primarily in the first frequency band between 210 nm and 365 nm and light in the second UV frequency band to the subject;
wherein the subject is selected from a group consisting of: a liquid, a bacteria, a virus, a pathogen, DNA, RNA, and organic material.

19. The method of claim 11 further comprising
directing the light primarily in the first frequency band between 210 nm and 365 nm and light in the second UV frequency band across a surface of a subject;
wherein the subject is selected from a group consisting of: a surface of printed media, a surface with an ink mixture, and a surface with a photo-initiator.

20. The method of claim 11 wherein a peak frequency associated with the first plurality of UV-LEDs is different from a peak frequency associated with the second plurality of UV-LEDs by about 20 nm.
